(19) United States
(12) Patent Application Publication
(10) Pub. No.: US 2024/0330073 A1
(43) Pub. Date: Oct. 3, 2024

(54) ARITHMETIC PROCESSING APPARATUS AND ARITHMETIC PROCESSING METHOD

(71) Applicant: Mitsubishi Electric Corporation, Tokyo (JP)

(72) Inventor: Kentaro MORI, Tokyo (JP)

(73) Assignee: Mitsubishi Electric Corporation, Tokyo (JP)

(21) Appl. No.: 18/427,149

(22) Filed: Jan. 30, 2024

(30) Foreign Application Priority Data
Mar. 28, 2023 (JP) 2023-050931

(51) Int. Cl. G06F 9/50; G06F 9/4401

(52) U.S. Cl. CPC G06F 9/5077; G06F 9/4406; G06F 9/5055

(57) ABSTRACT

To provide an arithmetic processing apparatus and an arithmetic processing method which can speed up a starting of a plurality of OSs, or can speed up a specific application system after the completion of the starting of the plurality of OSs, in a virtualization system using a virtualization technology. An arithmetic processing apparatus, during the starting of the OSs of the prescribed number, makes the resources assigned to the OS in the entire starting more than the resources of the OS in the entire starting which is set in the prescribed resource distribution; and, when the started OS is the specific OS, makes the resources assigned to the started specific OS less than the resources of the specific OS which is set in the prescribed resource distribution, and assigns reduced resources to the OS in the entire starting.

### INCORPORATION BY REFERENCE

The disclosure of Japanese Patent Application No. 2023-50931 filed on Mar. 28, 2023 including its specification, claims and drawings, is incorporated herein by reference in its entirety.

### BACKGROUND

This present disclosure relates to an arithmetic processing apparatus and an arithmetic processing method.

Previously, a technology which can execute a plurality of operating systems (OS) in parallel by the virtualization technology has been known. For example, in the technology of JP 2010-277177 A, two OSs are operated in parallel on a plurality of virtual processor cores.

In the technology of JP 2020-201762 A, when completing a starting of each of a plurality of OSs in order on the virtualization system, the number of the virtual processor cores assigned to the first OS during the starting of the first OS is made more than the number of the virtual processor cores assigned to the first OS after the completion of the starting of all the OSs. And, the starting of the first OS is speeded up.

### SUMMARY

However, in the technology of the JP 2020-201762 A, although the starting of the first OS which is started first is speeded up, the starting of the OS which is started last is not speeded up. Recently, the functions of the arithmetic processing apparatus for the vehicle are diverse, three or more OSs may be provided. However, in the technology of JP 2020-201762 A, a case where three or more OSs are provided is not considered, the starting of the OS which is started middle is not speeded up. In the technology of JP 2020-201762 A, the distribution of RAM during starting is not considered, it is insufficient to speed up the starting.

In the technology of JP 2020-201762 A, the speeding up of the starting of each OS when a plurality of OSs are started in parallel is not considered.

After the completion of the starting of the plurality of OSs, it is desirable to temporarily speed up the operation of the specific application system executed on each OS. However, in the technology of JP 2020-201762 A, the temporary speeding up of the operation of the specific application system is not considered,

Then, the purpose of the present disclosure is to provide an arithmetic processing apparatus and an arithmetic processing method which can speed up a starting of a plurality of OSs, or can speed up a specific application system after the completion of the starting of the plurality of OSs, in a virtualization system using a virtualization technology.

A first arithmetic processor according to the present disclosure, including:
a physical processor and a memory used by the physical processor;
a virtualization unit that generates a virtualization system having a plurality of virtual processor cores and a virtual memory that operates using the physical processor and the memory; and
an operation control unit that determines an operating number of OSs which are operating systems operating on the virtualization system, and a resource distribution which is a number of the virtual processor cores and a region of the virtual memory to be assigned to each of the OSs of the operating number, and operates the OSs of the operating number according to the resource distribution,
wherein the operation control unit completes a starting of each of the OSs of two or more prescribed numbers in order, according to a start completion order, after a completion of a generation of the virtualization system;
sets the resource distribution assigned to each of OSs of the prescribed number, to a preliminarily set prescribed resource distribution, after a completion of the starting of the OSs of the prescribed number;
during the starting of the OSs of the prescribed number, makes a number of the virtual processor cores and a region of the virtual memory to be assigned to the OS during an entire starting which starts the entire OS more than the number of the virtual processor cores and the region of the virtual memory of the OS during the entire starting which are set in the prescribed resource distribution; and
when the started OS is a specific OS, makes a number of the virtual processor cores and a region of the virtual memory to be assigned to the specific OS less than the number of the virtual processor cores and the region of the virtual memory of the specific OS which are set in the prescribed resource distribution, and assigns reduced resources to the OS during the entire starting.

A second arithmetic processor according to the present disclosure, including:
a physical processor and a memory used by the physical processor;
a virtualization unit that generates a virtualization system having a plurality of virtual processor cores and a virtual memory that operates using the physical processor and the memory; and
an operation control unit that determines an operating number of OSs which are operating systems operating on the virtualization system, and a resource distribution which is a number of the virtual processor cores and a region of the virtual memory to be assigned to each of the OSs of the operating number, and operates the OSs of the operating number according to the resource distribution,
wherein the operation control unit completes a starting of each of the OSs of two or more prescribed numbers in order, according to a start completion order, after a completion of a generation of the virtualization system; and sets the resource distribution assigned to each of OSs of the prescribed number, to a preliminarily set prescribed resource distribution, after a completion of the starting of the OSs of the prescribed number,
wherein each of the OSs of the prescribed number is provided with an operating state monitoring unit that monitors an operating state of the own OS,
wherein, during the starting of the OSs of the prescribed number, the operation control unit assigns, to the OS before the start of the entire starting, a minimum number of the virtual processor cores and a minimum region of the virtual memory which are less than the number of the virtual processor cores and the region of the virtual memory of the OS before the start of the entire starting which are set in the prescribed resource distribution, and are for operating at least the operating state monitoring unit of the OS before the start of the entire starting; and starts partially and operates the operating state monitoring unit of the OS, before the start of the entire starting;
wherein the operating state monitoring unit of each of the OSs transmits a starting status of the corresponding OS to the operation control unit,
wherein the operation control unit starts the entire starting of each of the OSs in order, according to the start completion order, based on the starting status of each of the OSs transmitted from the operating state monitoring unit of each of the OSs; and completes the starting of each of the OSs of the prescribed number in order.

A third arithmetic processing apparatus according to the present disclosure, including:
a physical processor and a memory used by the physical processor;
a virtualization unit that generates a virtualization system having a plurality of virtual processor cores and a virtual memory that operates using the physical processor and the memory; and
an operation control unit that determines a resource distribution which is a number of the virtual processor cores and a region of the virtual memory to be assigned to each of OSs which are operating systems of a prescribed number operating on the virtualization system, and operates the OSs of the prescribed number according to the resource distribution,
wherein, after a completion of a starting of the OSs of the prescribed number,
when one or a plurality of preliminarily set specific APPs are included in one or a plurality of APPs which are application systems executed on each the OS, the operation control unit determines a highest priority specific APP which is the specific APP with the highest priority, from the included one or the plurality of specific APPs; determines a priority resource distribution which is the resource distribution corresponding to the highest priority specific APP; and sets the priority resource distribution as the resource distribution,
when the one or the plurality of specific APPs are not included, the operation control unit determines a prescribed resource distribution; and sets the prescribed resource distribution as the resource distribution, and in the priority resource distribution, the operation control unit makes a number of the virtual processor cores and a region of the virtual memory to be assigned to a highest priority corresponding OS which is the OS on which the highest priority specific APP is executed more than the number of the virtual processor cores and the region of the virtual memory of the highest priority corresponding OS which are set in the prescribed resource distribution.

A first arithmetic processing method according to the present disclosure that makes a physical processor and a memory used by the physical processor perform each following step, including:
a virtualization step of generating a virtualization system having a plurality of virtual processor cores and a virtual memory that operates using the physical processor and the memory; and
an operation control step of determining an operating number of OSs which are operating systems operating on the virtualization system, and a resource distribution which is a number of the virtual processor cores and a region of the virtual memory to be assigned to each of the OSs of the operating number, and operating the OSs of the operating number according to the resource distribution,
wherein, in the operation control step, completing a starting of each of the OSs of two or more prescribed numbers in order, according to a start completion order, after a completion of a generation of the virtualization system;
setting the resource distribution assigned to each of OSs of the prescribed number, to a preliminarily set prescribed resource distribution, after a completion of the starting of the OSs of the prescribed number;
during the starting of the OSs of the prescribed number, making a number of the virtual processor cores and a region of the virtual memory to be assigned to the OS during an entire starting which starts the entire OS more than the number of the virtual processor cores and the region of the virtual memory of the OS during the entire starting which are set in the prescribed resource distribution; and
when the started OS is a specific OS, making a number of the virtual processor cores and a region of the virtual memory to be assigned to the specific OS less than the number of the virtual processor cores and the region of the virtual memory of the specific OS which are set in the prescribed resource distribution, and assigning reduced resources to the OS during the entire starting.

A second arithmetic processing method according to the present disclosure that makes a physical processor and a memory used by the physical processor perform each following step, including:
a virtualization step of generating a virtualization system having a plurality of virtual processor cores and a virtual memory that operates using the physical processor and the memory; and
an operation control step of determining an operating number of OSs which are operating systems operating on the virtualization system, and a resource distribution which is a number of the virtual processor cores and a region of the virtual memory to be assigned to each of the OSs of the operating number, and operating the OSs of the operating number according to the resource distribution,
wherein, in the operation control step, completing a starting of each of the OSs of two or more prescribed numbers in order, according to a start completion order, after a completion of a generation of the virtualization system; and
setting the resource distribution assigned to each of OSs of the prescribed number, to a preliminarily set prescribed resource distribution, after a completion of the starting of the OSs of the prescribed number,
wherein each of the OSs of the prescribed number is provided with an operating state monitoring unit that monitors an operating state of the own OS,
wherein, in the operation control step, during the starting of the OSs of the prescribed number, assigning, to the OS before the start of the entire starting, a minimum number of the virtual processor cores and a minimum region of the virtual memory which are less than the number of the virtual processor cores and the region of the virtual memory of the OS before the start of the entire starting which are set in the prescribed resource distribution, and are for operating at least the operating state monitoring unit of the OS before the start of the entire starting; and starting partially and operates the operating state monitoring unit of the OS, before the start of the entire starting,
wherein, in the operation control step, starting the entire starting of each of the OSs in order, according to the start completion order, based on the starting status of each of the OSs transmitted from the operating state monitoring unit of each of the OSs; and completing the starting of each of the OSs of the prescribed number in order.

A third arithmetic processing method according to the present disclosure that makes a physical processor and a memory used by the physical processor perform each following step, including:
a virtualization step of generating a virtualization system having a plurality of virtual processor cores and a virtual memory that operates using the physical processor and the memory; and
an operation control step of determining a resource distribution which is a number of the virtual processor cores and a region of the virtual memory to be assigned to each of OSs which are operating systems of a prescribed number operating on the virtualization system, and operating the OSs of the prescribed number according to the resource distribution,
wherein, in the operation control step, after a completion of a starting of OSs of the prescribed number,
when one or a plurality of preliminarily set specific APPs are included in one or a plurality of APPs which are application systems executed on each the OS, determining a highest priority specific APP which is the specific APP with the highest priority, from the included one or the plurality of specific APPs; determining a priority resource distribution which is the resource distribution corresponding to the highest priority specific APP; and setting the priority resource distribution as the resource distribution,
when the one or the plurality of specific APPs are not included, determining a prescribed resource distribution; and setting the prescribed resource distribution as the resource distribution,
in the priority resource distribution, the operation control unit makes a number of the virtual processor cores and a region of the virtual memory to be assigned to a highest priority corresponding OS which is the OS on which the highest priority specific APP is executed more than the number of the virtual processor cores and the region of the virtual memory of the highest priority corresponding OS which are set in the prescribed resource distribution.

According to the first arithmetic processor and the first arithmetic processing method of the present disclosure, the resource assigned to the OS during the entire starting are made more than the resource of the OS during the entire starting which are set in the prescribed resource distribution. And, when the started OS is the specific OS, the resources of the started specific OS are made less than the resources of the specific OS which are set in the prescribed resource distribution, and the reduced resources are assigned to the OS during the entire starting. Accordingly, for not only the OS started first, but also the OSs started last and middle, the starting of the OSs can be speeded up using the resources more than the resources in prescribed resource distribution.

According to the second arithmetic processor and the second arithmetic processing method of the present disclosure, since the operating state monitoring unit of each OS is started and operated in parallel before the start of the entire starting of each OS, the starting status of each OS can be determined accurately and quickly, and the starting of the OSs of the prescribed number can be executed accurately and rapidly. Since the minimum resources less than the resources of the prescribed resource distribution are assigned to the operating state monitoring unit of the OS before the start of the entire starting, the resources of the OS during the entire starting is increased more than the resources of the prescribed resource distribution, and the starting of the OS during the entire starting can be speeded up.

According to the third arithmetic processor and the third arithmetic processing method of the present disclosure, after the completion of the starting of OSs of the prescribed number, the resources of the OS which executes the highest priority specific APP to be executed with priority is increased more than the resources of the prescribed resource distribution, and the execution of the highest priority specific APP can be speeded up.

### BRIEF DESCRIPTION OF THE DRAWINGS

FIG. 1 is a schematic block diagram of the arithmetic processing apparatus, according to Embodiment 1;

FIG. 2 is a figure for explaining the prescribed resource distribution, according to Embodiment 1;

FIG. 3 is a figure for explaining the resource distribution during the starting of the first OS, according to Embodiment 1;

FIG. 4 is a figure for explaining the resource distribution during the starting of the second OS, according to Embodiment 1;

FIG. 5 is a figure for explaining the resource distribution during the starting of the third OS, according to Embodiment 1;

FIG. 6 is a figure for explaining another example of the resource distribution during the starting of the second OS, according to Embodiment 1;

FIG. 7 is a figure for explaining the resource distribution table data, according to Embodiment 1;

FIG. 8 is a flowchart for explaining processing of the arithmetic processing apparatus, according to Embodiment 1;

FIG. 9 is a figure for explaining the prescribed resource distribution, according to Embodiment 2;

FIG. 10 is a figure for explaining the resource distribution during the starting of the first OS, according to Embodiment 2;

FIG. 11 is a figure for explaining the resource distribution during the starting of the second OS, according to Embodiment 2;

FIG. 12 is a figure for explaining another example of the resource distribution during the starting of the second OS, according to Embodiment 2;

FIG. 13 is a figure for explaining the resource distribution during the starting of the third OS, according to Embodiment 2;

FIG. 14 is a figure for explaining another example of the resource distribution during the starting of the third OS, according to Embodiment 2;

FIG. 15 is a figure for explaining the resource distribution table data, according to Embodiment 2;

FIG. 16 is a flowchart for explaining processing of the arithmetic processing apparatus, according to Embodiment 2;

FIG. 17 is a figure for explaining the prescribed resource distribution, according to Embodiment 3;

FIG. 18 is a figure for explaining the resource distribution at the execution time of the third APP which is the specific APP, according to Embodiment 3;

FIG. 19 is a figure for explaining the resource distribution at the execution time of the third APP and the second APP which are the specific APPs, according to Embodiment 3;

FIG. 20 is a figure for explaining the resource distribution at the execution time of the second APP which is the specific APP, according to Embodiment 3;

FIG. 21 is a figure for explaining the resource distribution table data, according to Embodiment 3; and

FIG. 22 is a flowchart for explaining processing of the arithmetic processing apparatus, according to Embodiment 3.

### DETAILED DESCRIPTION OF THE EMBODIMENTS

### 1. Embodiment 1

An arithmetic processing apparatus 1 according to Embodiment 1 will be explained with reference to drawings. The arithmetic processing apparatus 1 is mounted in a vehicle, and is the arithmetic processing apparatus for the vehicle. The arithmetic processing apparatus 1 may be used as the arithmetic processing apparatus of various kinds of applications other than the arithmetic processing apparatus for the vehicle.

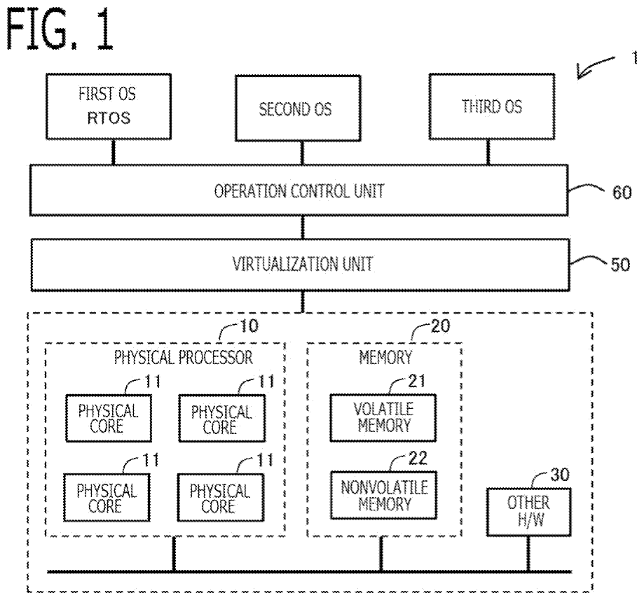

As shown in FIG. 1, the arithmetic processing apparatus 1 is provided with a physical processor 10, a memory 20 used by the physical processor 10, a virtualization unit 50, an operation control unit 60, and the like. In the present embodiment, the arithmetic processing apparatus 1 also is provided with other hardware 30 (also referred to as other H/W 30).

The physical processor 10, the memory 20, and the other hardware 30 are hardware. As the memory 20, a volatile memory 21, such as RAM (Random Access Memory), and a nonvolatile memories 22, such as ROM (Read Only Memory), SSD (Solid State Drive), and eMMC (embedded Multi Media Card) are provided.

The virtualization unit 50, the operation control unit 60, each operating system (OS), and each application system (APP) are functional units realized by software. Each functional unit, such as the virtualization unit 50 and the operation control unit 60, is realized by the physical processor 10 executing a software (program) stored in the memory 20 (the nonvolatile memory 22) and the like and cooperating with other hardware, such as the memory 20 (the volatile memory 21, the nonvolatile memory 22) and other hardware 30.

The other hardware 30 include various kinds of hardware, such as GPU (Graphics Processing Unit) or a processing unit for AI (Artificial Intelligence) processing mounted on SoC (System-on-a-chip), an input and output device and a communication device.

The physical processor 10 is provided with a plurality of physical processor cores 11 (hereinafter, referred to as physical cores 11). In the present embodiment, the four physical cores 11 are provided.

### <Virtualization Unit 50>

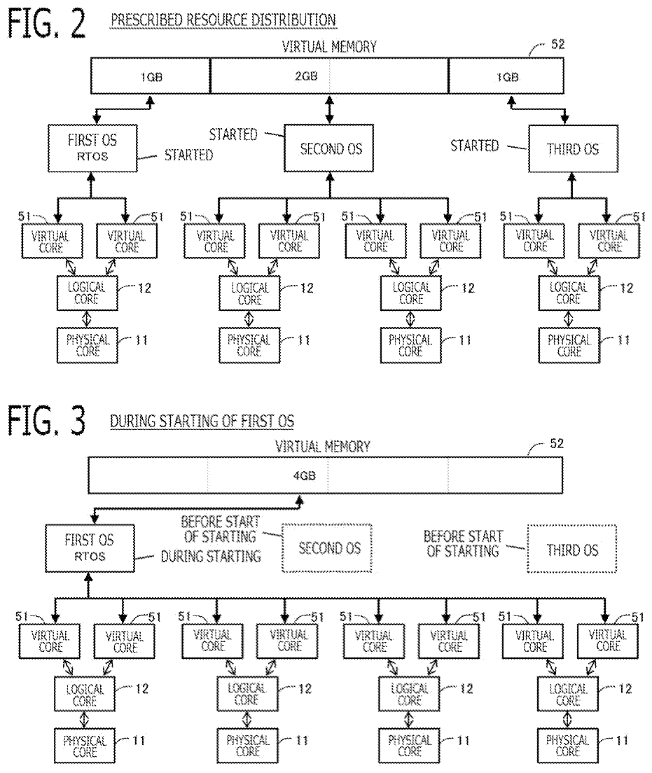

As shown in FIG. 2, the virtualization unit 50 generates a virtualization system having a plurality of virtual processor cores 51 (hereinafter, referred to as virtual cores 51) and a virtual memory 52 that operate using the physical processor 10 and the memory 20. The virtualization unit 50 functions by execution of a virtualization software, such as Hypervisor.

The virtualization unit 50 operates the physical processor 10 as if there are a plurality of cores (that is, the virtual cores 51) virtually, by performing a time division of the resource of the physical processor 10 per clock by the virtualization software. The virtualization unit 50 associates the virtual core 51 with a thread (hereinafter, referred to as a logical core 12) which is a minimum processing unit executed by the physical core 11, and manages it. In the present embodiment, one physical core 11 executes one logical core 12. By using SMT (Simultaneous Multithreading Technology), two logical cores 12 may be executed in parallel on one physical core 11.

In the present embodiment, the two virtual cores 51 are generated for one logical core 12. One, or three or more virtual cores 51 may be generated for one logical core 12.

The virtualization unit 50 generates the virtual memory 52 using the volatile memory 21, such as RAM. The virtualization unit 50 makes each OS use other H/W 30 in parallel.

When a power source of the vehicle is tuned on, the electric power supply to the arithmetic processing apparatus 1 starts. Then, the virtualization unit 50 is started. Specifically, the physical processor 10 reads and executes a virtualization software stored in the nonvolatile memory 22, starts the virtualization unit 50, and generates the virtualization system.

### <Operation Control Unit 60>

The operation control unit 60 determines an operating number of OSs which are operating systems operating on the virtualization system, and a resource distribution which is a number of the virtual cores 51 and a region of the virtual memory 52 to be assigned to each of the OSs of the operating number, and operates the OSs of the operating number according to the resource distribution. The operation control unit 60 also functions by execution of the virtualization software, such as Hypervisor. The operation control unit 60 generates a virtual computer corresponding to each OS, and operates each OS on the each virtual computer. As explained in Embodiment 3, various kinds of application systems (APPs) are started and operated arbitrarily on each OS.

The operation control unit 60 determines a time occupancy of other H/W 30 for each OS, and makes each OS use other H/W 30 according to the determined time occupancy for each OS. In the present embodiment, the time occupancy for each OS is assumed to be set according to the assignment number of the virtual cores 51 for each OS, and explanation is omitted.

As described later, the operation control unit 60 completes a starting of each of the OSs of two or more prescribed numbers in order, according to a start completion order, after a completion of a generation of the virtualization system. Then, the operation control units 60 sets the resource distribution assigned to each of OSs of the prescribed number, to a preliminarily set prescribed resource distribution, after a completion of the starting of the OSs of the prescribed number.

In the present embodiment, a case where the prescribed number is set to 3, and a first OS, a second OS, and a third OS are started will be explained as an example. The prescribed number may be set to two or more arbitrary natural numbers. The first OS is RTOS which is a real time operating system. The second OS and the third OS are general-purpose OSs which are not RTOS. Between the virtualization software such as Hypervisor, and RTOS, a kernel may be standardized or may not be standardized.

### <Example of Prescribed Resource Distribution>

FIG. 2 shows a state where the resource distribution is set to the prescribed resource distribution, after the completion of the starting of the OSs of the prescribed number. In the prescribed resource distribution, the two virtual cores 51 and 1 GB region of the virtual memory 52 are assigned to the first OS (RTOS), and the first OS (RTOS) operates using these resources. The four virtual cores 51 and 2 GB region of the virtual memory 52 are assigned to the second OS, and the second OS operates using these resources. The two virtual cores 51 and 1 GB region of the virtual memory 52 are assigned to the third OS, and the third OS operates using these resources.

### <Resource Distribution at Starting of Each OS>

The operation control unit 60 completes a starting of each of the OSs of the prescribed numbers in order, according to a start completion order, after a completion of a generation of the virtualization system. In the present embodiment, the OSs of the prescribed number are started in order, according to the start completion order. During the starting of the OSs of the prescribed number, the operation control unit 60 makes a number of the virtual cores 51 and a region of the virtual memory 52 to be assigned to the OS during an entire starting which starts the entire OS more than the number of the virtual cores 51 and the region of the virtual memory 52 of the OS during the entire starting which are set in the prescribed resource distribution. When the started OS is a specific OS, the operation control unit 60 makes a number of the virtual cores 51 and a region of the virtual memory 52 to be assigned to the specific OS less than the number of the virtual cores 51 and the region of the virtual memory 52 of the specific OS which are set in the prescribed resource distribution; and assigns reduced resources to the OS during the entire starting.

Herein, the entire starting is used in order to clarify a difference from a partial starting which starts partially the operating state monitoring unit 70 of each OS in Embodiment 2. In the present disclosure, the entire starting is sometimes referred to simply as the starting.

According to this configuration, the resources assigned to the OS during the entire starting are made more than the resources of the OS during the entire starting which are set in the prescribed resource distribution. And, when the started OS is a specific OS, the resources of the started specific OS is made less than the resources of the specific OS which are set in the prescribed resource distribution, and the reduced resources are assigned to the OS during the entire starting. Accordingly, for not only the OS started first, but also the OSs started last and middle, the starting of the OSs can be speeded up using the resources more than the resources in prescribed resource distribution.

In the present embodiment, the first OS, the second OS, and the third OS are started in this order. Since the first OS is RTOS, RTOS is started first. Accordingly, RTOS can be started first, and processing with high real time property required for a vehicle control can be started.

FIG. 3 shows an example of the resource distribution during the entire starting of the first OS (RTOS). The first OS (RTOS) during the entire starting is assigned the eight virtual cores 51 and 4 GB region of the virtual memory 52 which are more than the resources (two, 1 GB) of the first OS set in the prescribed resource distribution of FIG. 2. The first OS (RTOS) is started using these resources. The second OS and the third OS before the start of the entire starting are not assigned the resources. Accordingly, the starting of the first OS can be speeded up using all the resources.

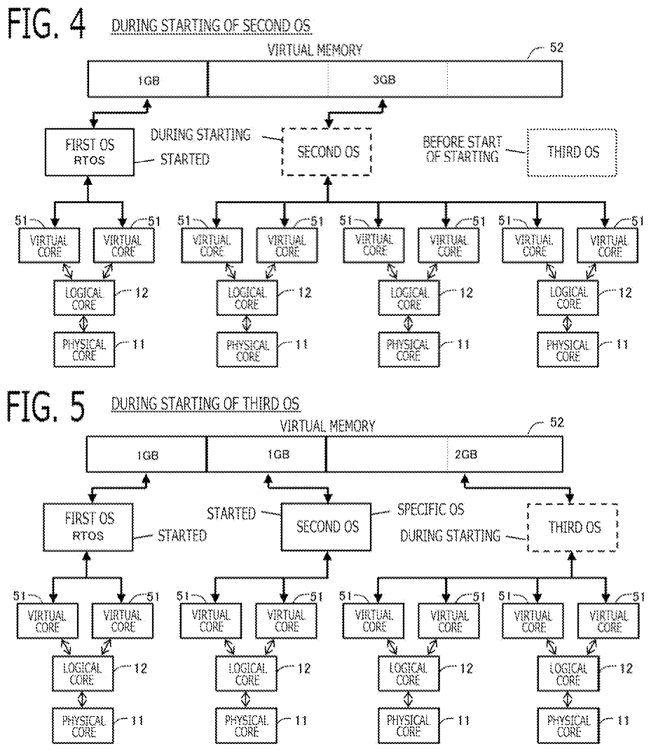

FIG. 4 shows an example of the resource distribution during the entire starting of the second OS after the completion of the starting of the first OS (RTOS). In the example of FIG. 4, since the first OS (RTOS) is not set as the specific OS, the started first OS (RTOS) is assigned the two virtual cores 51 and 1 GB region of the virtual memory 52 which are the same as the resource (two, 1 GB) of the first OS set in the prescribed resource distribution of FIG. 2. Accordingly, the processing with high real time property of RTOS can be executed more certainly. The second OS during the entire starting is assigned the six virtual cores 51 and 3 GB region of the virtual memory 52 which are more than the resources (four, 2 GB) of the second OS set in the prescribed resource distribution of FIG. 2. The second OS is started using these resources. The third OS before the start of the entire starting is not assigned the resources. Accordingly, the starting of the second OS can be speeded up using the resources more than the prescribed resource distribution.

FIG. 5 shows an example of the resource distribution during the entire starting of the third OS after the completion of the starting of the first OS and the second OS. The started first OS (RTOS) is assigned the two virtual cores 51 and 1 GB region of the virtual memory 52 which are the same as the resource (two, 1 GB) of the first OS set in the prescribed resource distribution of FIG. 2. In the example of FIG. 5, since the second OS is set as the specific OS, the started second OS is assigned the two virtual cores 51 and 1 GB region of the virtual memory 52 which are less than the resources (four, 2BG) of the second OS set in the prescribed resource distribution of FIG. 2. This reduced resource of the second OS which is the started specific OS is assigned to the third OS during the entire starting. Accordingly, the third OS during the entire starting is assigned the four virtual cores 51 and 2 GB region of the virtual memory 52 which are more than the resources (two, 1 GB) of the third OS set in the prescribed resource distribution of FIG. 2. The third OS is started using these resources. Accordingly, also for the third OS started last, by assigning the reduced resources of the started specific OS, the starting of the third OS can be speeded up using the resources more than the prescribed resource distribution. Although the resources of the second OS which is the specific OS is made less than the prescribed resource distribution, there is no particular problem, since the resources are reduced within a range that the second OS can continue operation.

Then, after the completion of the starting of the third OS, it becomes in the state of the prescribed resource distribution shown in FIG. 2.

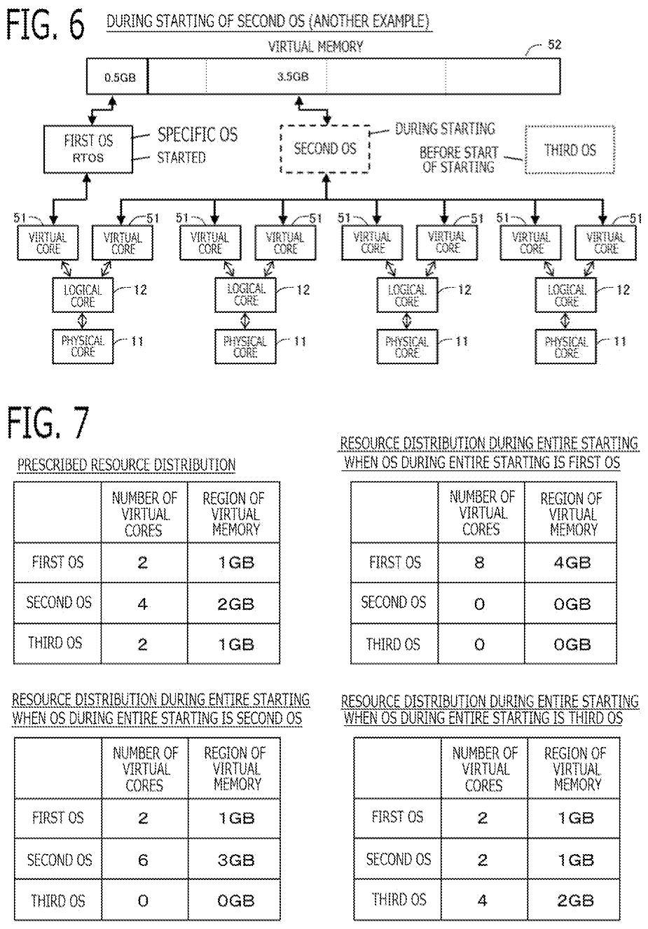

Both the first OS and the second OS may be set as the specific OS, or only the first OS may be set as the specific OS. FIG. 6 shows an example of the resource distribution during the entire starting of the second OS, when the first OS (RTOS) is set as the specific OS. The started first OS (RTOS) which is the specific OS is assigned the one virtual core 51 and 0.5 GB region of the virtual memory 52 which are less than the resources (two, 1BG) of the first OS set in prescribed resource distribution of FIG. 2. This reduced resource of the first OS which is the started specific OS is assigned to the second OS during the entire starting. Accordingly, the second OS during the entire starting is assigned the seven virtual cores 51 and 3.5 GB region of the virtual memory 52 which are more than the resources (four, 2 GB) of the second OS set in the prescribed resource distribution of FIG. 2. The second OS is started even faster using these resources. Although the resources of the first OS (RTOS) which is the specific OS is made less than the prescribed resource distribution, there is no particular problem, since the resources are reduced within a range that the first OS can continue operation.

In this way, the specific OS may be set to one or a plurality of OSs other than OS started last. As mentioned above, by assigning the reduced resources of the started specific OS also to the OS started last and the OS started middle after the specific OS, the starting can be speeded up using the resources more than the prescribed resource distribution.

By referring to a resource distribution table data in which the prescribed resource distribution and a resource distribution during the entire starting which is a resource distribution set for each the OS during the entire starting are preliminarily set as shown in FIG. 7, the operation control unit 60 reads the prescribed resource distribution or the resource distribution during the entire starting corresponding to a present starting status, and sets as the resource distribution. In detail, when the present starting status is after the completion of the starting of OSs of the prescribed number, the operation control unit 60 reads the prescribed resource distribution from the resource distribution table data, and sets it as the resource distribution. When the present starting status is during the entire starting of any one of the OSs, the operation control unit 60 reads the resource distribution during the entire starting corresponding to the OS presently during the entire starting, and sets it as the resource distribution. The resource distribution table data is preliminarily stored in the nonvolatile memories 22, such as ROM.

### <Flowchart>

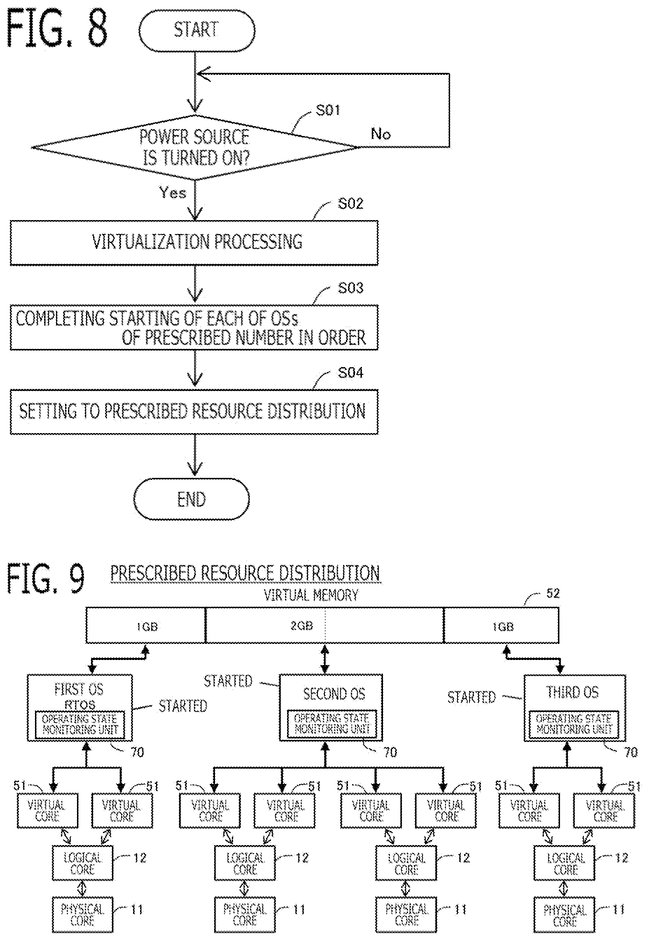

FIG. 8 is a schematic flowchart explaining processing of the arithmetic processing apparatus 1 (an arithmetic processing method) according to the present embodiment. The processing of FIG. 8 is executed by the physical processor 10 executing the software (program) stored in the memory 20 (the nonvolatile memory 22) and the like.

In the step S01, when the power source of the arithmetic processing apparatus 1 is turned on by turning on the power source of the vehicle, it advances to the step S02, and the virtualization unit 50 starts a virtualization processing.

In the step S02, as mentioned above, the virtualization unit 50 executes a virtualization processing (a virtualization step) of generating a virtualization system having a plurality of virtual processor cores 51 (hereinafter, to as virtual cores 51) and a virtual memory 52 that operate using the physical processor 10 and the memory 20.

After the completion of the generation of the virtualization system, in the step S03 to the step S04, as mentioned above, the operation control unit 60 executes an operation control processing (an operation control step) of determining an operating number of OSs which are operating systems operating on the virtualization system, and a resource distribution which is a number of the virtual cores 51 and a region of the virtual memory 52 to be assigned to each of the OSs of the operating number, and operating the OSs of the operating number according to the resource distribution.

In the step S03, as mentioned above, the operation control unit 60 completes a starting of each of the OSs of two or more prescribed numbers in order, according to a start completion order, after a completion of a generation of the virtualization system.

During the starting of the OSs of the prescribed number, the operation control unit 60 makes a number of the virtual cores 51 and a region of the virtual memory 52 to be assigned to the OS during an entire starting which starts the entire OS more than the number of the virtual cores 51 and the region of the virtual memory 52 of the OS during the entire starting which are set in the prescribed resource distribution. And, when the started OS is a specific OS, the operation control unit 60 makes a number of the virtual cores 51 and a region of the virtual memory 52 to be assigned to the specific OS less than the number of the virtual cores 51 and the region of the virtual memory 52 of the specific OS which are set in the prescribed resource distribution; and assigns reduced resources to the OS during the entire starting.

In the step S04, as mentioned above, after a completion of the starting of the OSs of the prescribed number, the operation control units 60 sets the resource distribution assigned to each of the OSs of the prescribed number, to a preliminarily set prescribed resource distribution.

### 2. Embodiment 2

Next, the arithmetic processing apparatus 1 according to Embodiment 2 will be explained. The explanation for constituent parts the same as those in Embodiment 1 will be omitted. The basic configuration and processing of the arithmetic processing apparatus 1 according to the present embodiment are the same as those of Embodiment 1. Embodiment 2 is different from Embodiment 1 in that each of the OSs of the prescribed number is provided with an operating state monitoring unit 70 that monitors an operating state of the own OS, and during the starting of the OSs of the prescribed number, the resource is assigned to the operating state monitoring unit 70 of each OS.

In the present embodiment, as shown in FIG. 9, each of the OSs of the prescribed number is provided with an operating state monitoring unit 70 that monitors an operating state of the own OS.

Similarly to Embodiment 1, the operation control unit 60 completes a starting of each of the OSs of the prescribed numbers in order, according to a start completion order, after a completion of a generation of the virtualization system.

Then, during the starting of the OSs of the prescribed number, the operation control unit 60 assigns, to the OS before the start of the entire starting, a minimum number of the virtual processor cores and a minimum region of the virtual memory which are less than the number of the virtual processor cores and the region of the virtual memory of the OS before the start of the entire starting which are set in the prescribed resource distribution, and are for operating at least the operating state monitoring unit 70 of the OS before the start of the entire starting; and starts partially and operates the operating state monitoring unit 70 of the OS, before the start of the entire starting.

The operating state monitoring unit 70 of each of the OSs transmits a starting status of the corresponding OS to the operation control unit 60. The operation control unit 60 starts the entire starting of each of the OSs in order, according to the start completion order, based on the starting status of each of the OSs transmitted from the operating state monitoring unit 70 of each of the OSs; and completes the starting of each of the OSs of the prescribed number in order.

According to this configuration, since the operating state monitoring unit 70 of each OS is started and operated in parallel before the start of the entire starting of each OS, the starting status of each OS can be determined accurately and quickly, and the starting of the OSs of the prescribed number can be executed accurately and rapidly. Since the minimum resources less than the resources of the prescribed resource distribution are assigned to the operating state monitoring unit 70 of the OS before the start of the entire starting, the resources of the OS during the entire starting is increased more than the resources of the prescribed resource distribution, and the starting of the OS during the entire starting can be speeded up.

During the starting of the OSs of the prescribed number, the operation control unit 60 makes a number of the virtual cores 51 and a region of the virtual memory 52 to be assigned to the OS during the entire starting more than the number of the virtual cores 51 and the region of the virtual memory 52 of the OS during the entire starting which are set in the prescribed resource distribution. And, when the started OS is a specific OS, the operation control unit 60 makes a number of the virtual cores 51 and a region of the virtual memory 52 to be assigned to the specific OS less than the number of the virtual cores 51 and the region of the virtual memory 52 of the specific OS which are set in the prescribed resource distribution; and assigns reduced resources to the OS during the entire starting.

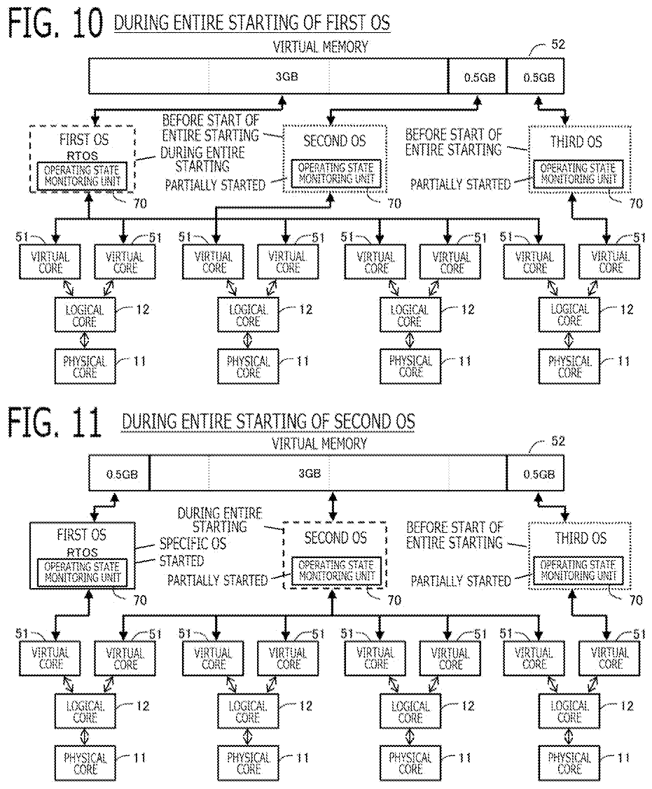

FIG. 10 shows an example of the resource distribution during the entire starting of the first OS (RTOS). Unlike Embodiment 1, each of the second OS and the third OS before the start of the entire starting is assigned the minimum resource (one virtual core 51, 0.5 GB) for operation of the operating state monitoring unit 70. At least, the operating state monitoring unit 70 is started partially and operated. Since the operating state monitoring units 70 of the second OS and the third OS are started and operated in parallel before the start of the entire starting of the second OS and the third OS, the starting status of the second OS and the third OS can be determined accurately and quickly. After the partial starting of the operating state monitoring unit 70 of each OS, the starting of the remaining OS part may be started by using the minimum resources.

The first OS (RTOS) during the entire starting is assigned the resources other than the minimum resources for the starting and the operation of the operating state monitoring units 70 of the second OS and the third OS before the start of the entire starting. As the result, the first OS (RTOS) during the entire starting is assigned the six virtual cores 51 and 3 GB region of the virtual memory 52 which are more than the resources (two, 1 GB) of the first OS set in the prescribed resource distribution of FIG. 9. The first OS (RTOS) is started using these resources. Accordingly, the starting of the first OS can be speeded up.

FIG. 11 shows an example of the resource distribution during the entire starting of the second OS after the completion of the starting of the first OS (RTOS). Unlike Embodiment 1, the third OS before the start of the entire starting is succeedingly assigned the minimum resources for the operation of the operating state monitoring unit 70 (one, 0.5 GB). At least, the operating state monitoring unit 70 is started partially and operated. Since the operating state monitoring unit 70 of the third OS is started and operated in parallel before the start of the entire starting of the third OS, the starting status of the third OS can be determined accurately and quickly. After the partial starting of the operating state monitoring unit 70, the starting of the remaining OS part may be started by using the minimum resources.

In the example of FIG. 11, since the first OS (RTOS) is set as the specific OS, the started first OS (RTOS) is assigned the one virtual core 51 and 0.5 GB region of the virtual memory 52 less than the resources (two, 1BG) of the first OS set in prescribed resource distribution of FIG. 9. Accordingly, the reduced resources of the first OS and the third OS which are reduced less than the prescribed resource distribution are assigned to the second OS during the entire starting. Accordingly, the second OS during the entire starting is assigned the six virtual cores 51 and 3 GB region of the virtual memory 52 which are more than the resources (four, 2 GB) of the second OS set in the prescribed resource distribution of FIG. 9. The starting of the second OS can be speeded up.

Alternatively, as shown in FIG. 12, the first OS (RTOS) may not be set as the specific OS, and the started first OS (RTOS) may be assigned the two virtual cores 51 and 1 GB region of the virtual memory 52 which are the same as the resource (two, 1 GB) of the first OS set in the prescribed resource distribution. Even in this case, since the reduced resources of the third OS which are reduced less than the prescribed resource distribution are assigned to the second OS during the entire starting, the starting of the second OS can be speeded up.

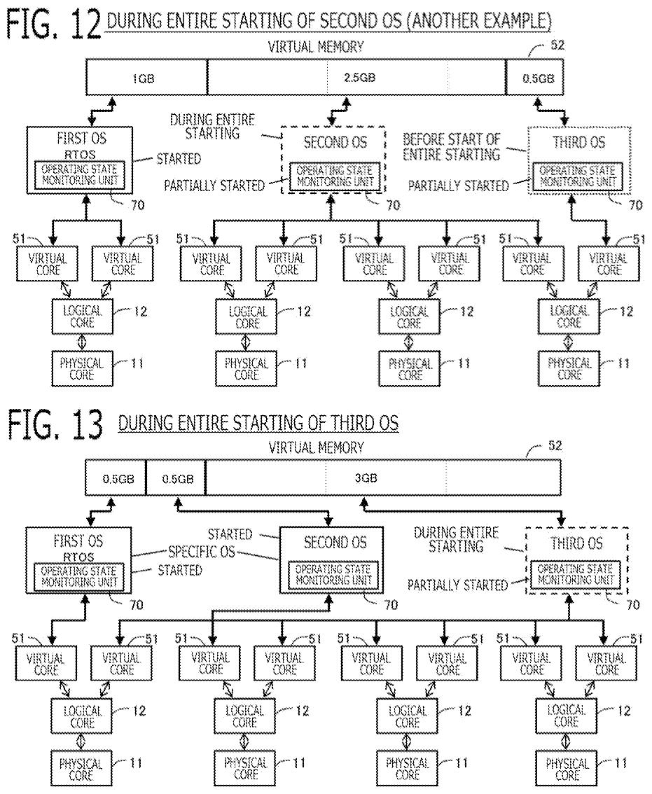

FIG. 13 shows an example of the resource distribution during the entire starting of the third OS after the completion of the starting of the first OS and the second OS. Since the first OS (RTOS) is set as the specific OS, the started first OS (RTOS) is assigned the one virtual core 51 and 0.5 GB region of the virtual memory 52 which are less than the resources (two, 1BG) of the first OS set in prescribed resource distribution of FIG. 9. Since the second OS is set as the specific OS, the started second OS is assigned the one virtual cores 51 and 0.5 GB region of the virtual memory 52 which are less than the resources (four, 2BG) of the first OS set in the prescribed resource distribution of FIG. 9. This reduced resources of the first OS and the second OS which are the started specific OSs are assigned to the third OS during the entire starting. Accordingly, the third OS during the entire starting is assigned the six virtual cores 51 and 3 GB region of the virtual memory 52 which are more than the resources (two, 1 GB) of the third OS set in the prescribed resource distribution of FIG. 9. The third OS is started using these resources. Accordingly, also for the third OS started last, by assigning the reduced resources of the started specific OS, the starting of the third OS can be speeded up using the resources more than the prescribed resource distribution.

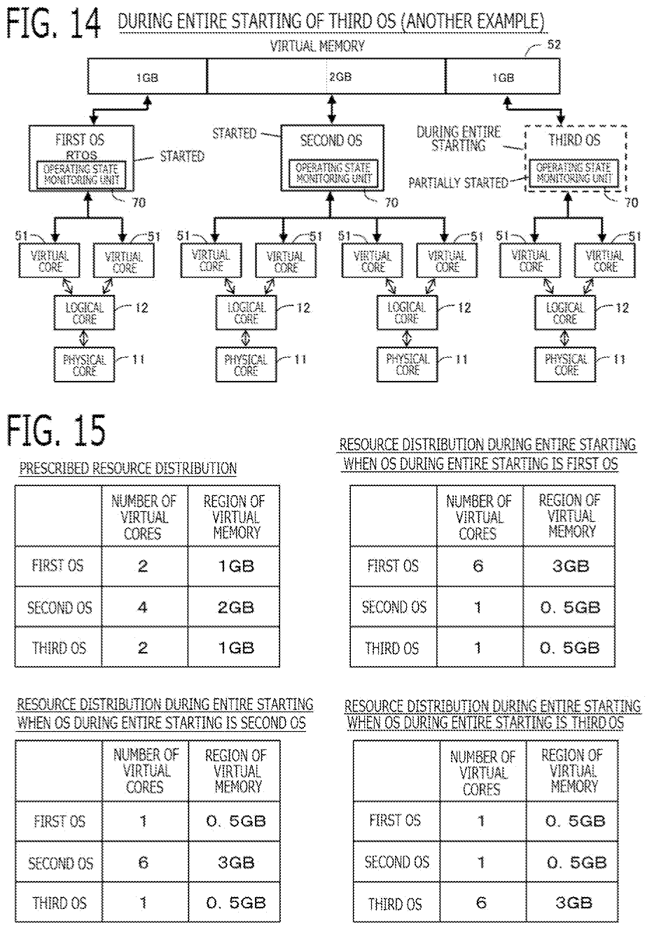

Alternatively, as shown in FIG. 14, the first OS and the second OS may not be set as the specific OS, and the started first OS and the started second OS may be assigned the resources which are the same as the resources (two, 1 GB) of the first OS and the resources (four, 2 GB) of the second OS which are set in the prescribed resource distribution.

Then, after the completion of the starting of the third OS, it becomes in the state of the prescribed resource distribution shown in FIG. 9.

Similarly to Embodiment 1, by referring to a resource distribution table data in which the prescribed resource distribution and a resource distribution during the entire starting which is a resource distribution set for each the OS during the entire starting are preliminarily set as shown in FIG. 15, the operation control unit 60 reads the prescribed resource distribution or the resource distribution during the entire starting corresponding to a present starting status, and sets it as the resource distribution. Unlike Embodiment 1, the OS before the start of the entire starting is assigned the minimum resources for the operation of at least the operating state monitoring unit 70, and is started partially.

### <Flowchart>

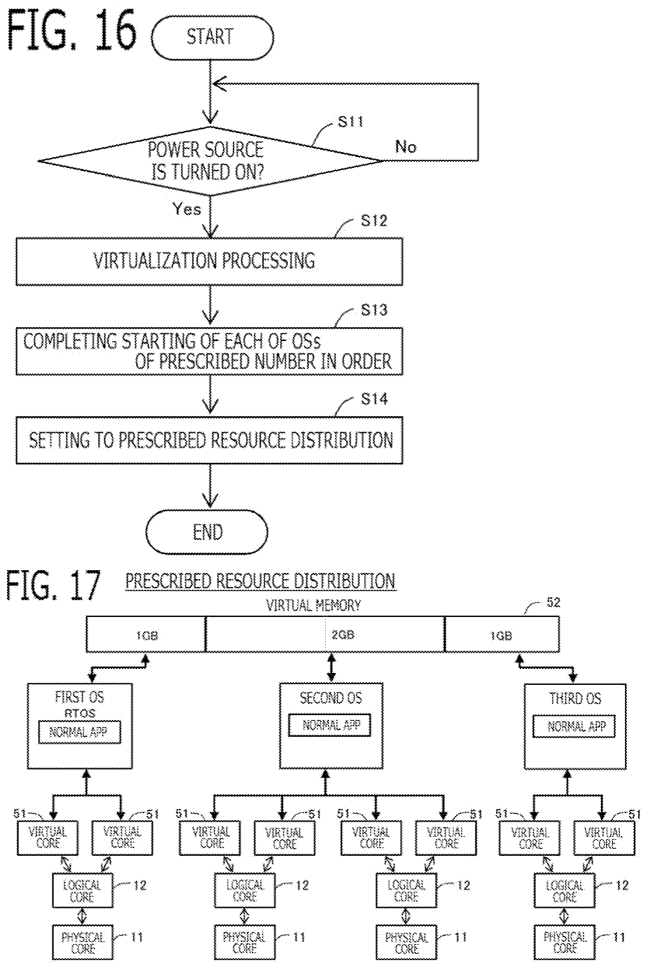

FIG. 16 is a schematic flowchart explaining processing of the arithmetic processing apparatus 1 (an arithmetic processing method) according to the present embodiment. The processing of FIG. 16 is executed by the physical processor 10 executing the software (program) stored in the memory 20 (the nonvolatile memory 22) and the like.

In the step S11, when the power source of the arithmetic processing apparatus 1 is turned on by turning on the power source of the vehicle, it advances to the step S12, and the virtualization unit 50 starts a virtualization processing.

In the step S12, similarly to Embodiment 1, the virtualization unit 50 executes a virtualization processing (a virtualization step) of generating a virtualization system having a plurality of virtual processor cores 51 (hereinafter, to as virtual cores 51) and a virtual memory 52 that operate using the physical processor 10 and the memory 20.

After the completion of the generation of the virtualization system, in the step S13 to the step S14, similarly to Embodiment 1, the operation control unit 60 executes an operation control processing (an operation control step) of determining an operating number of OSs which are operating systems operating on the virtualization system, and a resource distribution which is a number of the virtual cores 51 and a region of the virtual memory 52 to be assigned to each of the OSs of the operating number, and operating the OSs of the operating number according to the resource distribution.

In the step S13, as mentioned above, the operation control unit 60 completes a starting of each of the OSs of two or more prescribed numbers in order, according to a start completion order, after a completion of a generation of the virtualization system.

In the present embodiment, each of the OSs of the prescribed number is provided with an operating state monitoring unit 70 that monitors an operating state of the own OS. Then, during the starting of the OSs of the prescribed number, the operation control unit 60 assigns, to the OS before the start of the entire starting, a minimum number of the virtual processor cores and a minimum region of the virtual memory which are less than the number of the virtual processor cores and the region of the virtual memory of the OS before the start of the entire starting which are set in the prescribed resource distribution, and are for operating at least the operating state monitoring unit 70 of the OS before the start of the entire starting; and starts partially and operates the operating state monitoring unit 70 of the OS, before the start of the entire starting. The operating state monitoring unit 70 of each of the OSs transmits a starting status of the corresponding OS to the operation control unit 60. The operation control unit 60 starts the entire starting of each of the OSs in order, according to the start completion order, based on the starting status of each of the OSs transmitted from the operating state monitoring unit 70 of each of the OSs; and completes the starting of each of the OSs of the prescribed number in order.

Similarly to Embodiment 1, during the starting of the OSs of the prescribed number, the operation control unit 60 may make a number of the virtual cores 51 and a region of the virtual memory 52 to be assigned to the OS during the entire starting more than the number of the virtual cores 51 and the region of the virtual memory 52 of the OS during the entire starting which are set in the prescribed resource distribution. And, when the started OS is the specific OS, the operation control unit 60 may make a number of the virtual cores 51 and a region of the virtual memory 52 to be assigned to the specific OS less than the number of the virtual cores 51 and the region of the virtual memory 52 of the specific OS which are set in the prescribed resource distribution; and may assign reduced resources to the OS during the entire starting.

In the step S14, similarly to Embodiment 1, after a completion of the starting of the OSs of the prescribed number, the operation control units 60 sets the resource distribution assigned to each of OSs of the prescribed number, to a preliminarily set prescribed resource distribution.

### 3. Embodiment 3

Next, the arithmetic processing apparatus 1 according to Embodiment 3 will be explained. The explanation for constituent parts the same as that of Embodiment 1 or 2 will be omitted. The basic configuration and processing of the arithmetic processing apparatus 1 according to the present embodiment are the same as those of Embodiment 1 or 2. In the present embodiment, the setting method of the resource distribution after the completion of the starting of the OSs of the prescribed number is different from Embodiment 1.

After the completion of the starting of OSs of the prescribed number, when one or a plurality of preliminarily set specific APPs are included in one or a plurality of APPs which are application systems executed on each the OS, the operation control 60 determines a highest priority specific APP which is the specific APP with the highest priority, from the included specific APPs; determines a priority resource distribution which is the resource distribution corresponding to the highest priority specific APP; and sets the priority resource distribution as the resource distribution. When the one or the plurality of specific APPs are not included in the one or the plurality of APPs which are executed on each OS, the operation control 60 determines a prescribed resource distribution; and sets the prescribed resource distribution as the resource distribution.

In the priority resource distribution, the operation control unit 60 makes a number of the virtual processor cores and a region of the virtual memory to be assigned to a highest priority corresponding OS which is the OS on which the highest priority specific APP is executed more than the number of the virtual processor cores and the region of the virtual memory of the highest priority corresponding OS which are set in the prescribed resource distribution.

According to this configuration, the resources of the OS which executes the highest priority specific APP to be executed with priority is increased more than the resources of the prescribed resource distribution, and the execution of the highest priority specific APP can be speeded up.

For example, the specific APP is set to an APP for an emergency driving of the vehicle, and the priority of the APP for the emergency driving of the vehicle is made higher than other APPs. For example, as the emergency driving of the vehicle, there are an emergency avoidance driving of a peripheral object, an emergency stop of the vehicle, various kinds of rapid vehicle driving, and the like. As other APPs, there are various kinds of APPs for vehicle controls, such as a normal automatic driving, a driving support control (for example, a lane change control, a lane keeping control, and a vehicle distance control), and a route guide. As other APPs, there are various kinds of APPs for improving the convenience of user in the vehicle.

According to this configuration, when the APP for the emergency driving of the vehicle is executed, the resources of the OS which executes the APP for the emergency driving is increased more than the resources of the prescribed resource distribution, the execution of the APP for the emergency driving is speeded up, the real time property of the emergency driving is secured certainly, and the safety of the vehicle can be improved.

For example, the specific APP is set to an APP during a vehicle stop which is executed only during a stop of the vehicle, and the priority of the APP during the vehicle stop is made higher than other APPs which are executed also during other than the vehicle stop. For example, as the APP during the vehicle stop, there is an APP for an updating which updates the OS and the APP during the vehicle stop. The APP for the updating is OTA (Over The Air) and the like. As other APPs executed also during other than the vehicle stop, there are an APP for the vehicle driving, and the like.

According to this configuration, during the vehicle stop, the resources of the OS which executes the APP during the vehicle stop is increased more than the resources of prescribed resource distribution, the execution of the APP during the vehicle stop is speeded up, and the convenience of the vehicle can be improved.

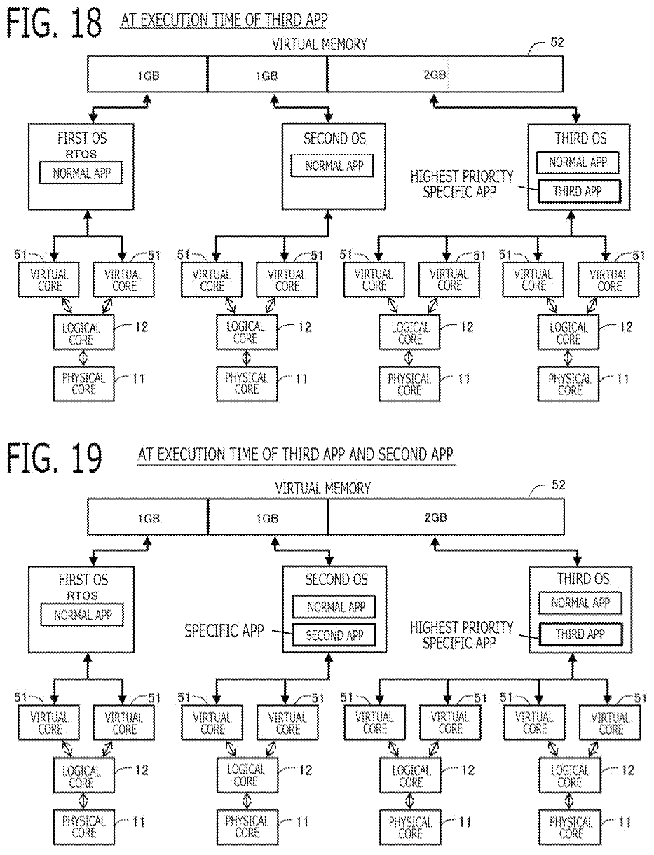

FIG. 18 shows an example of the resource distribution when a third APP set as the specific APP is executed on the third OS. Since other APPs currently executed are not the specific APP but the normal APPs, the third APP is determined to be the highest priority specific APP. Accordingly, the third OS is assigned the four virtual cores 51 and 2 GB region of the virtual memory 52 which are more than the resources (two, 1 GB) of the third OS set in the prescribed resource distribution of FIG. 17. The third OS and the third APP operate using these resources at higher speed than the state of the prescribed resource distribution. On the other hand, the second OS is assigned the two virtual cores 51 and 1 GB region of the virtual memory 52 which are less than the resources (four, 2BG) of the second OS set in the prescribed resource distribution of FIG. 17. However, since the resources are decreased within a range that the second OS can continue operation, there is no particular problem.

A usage priority of other H/W 30 of the third OS may be made higher than the usage priority of the first OS and the second OS. For example, as the usage priority of each OS becomes high, a time occupancy of other H/W 30 of each OS is increased.

FIG. 19 shows a case where the execution of the second APP which is set as the specific APP in the second OS is started during the execution of the third APP of the third OS shown in FIG. 18. However, as shown in FIG. 21, the priority of the second APP of the second OS is lower than the priority of the third APP of the third OS, the third APP of the third OS is determined succeedingly to be the highest priority specific APP. Accordingly, the resource distribution is not changed from the resource distribution of FIG. 18. As a value of the priority of FIG. 21 becomes large, the priority becomes high.

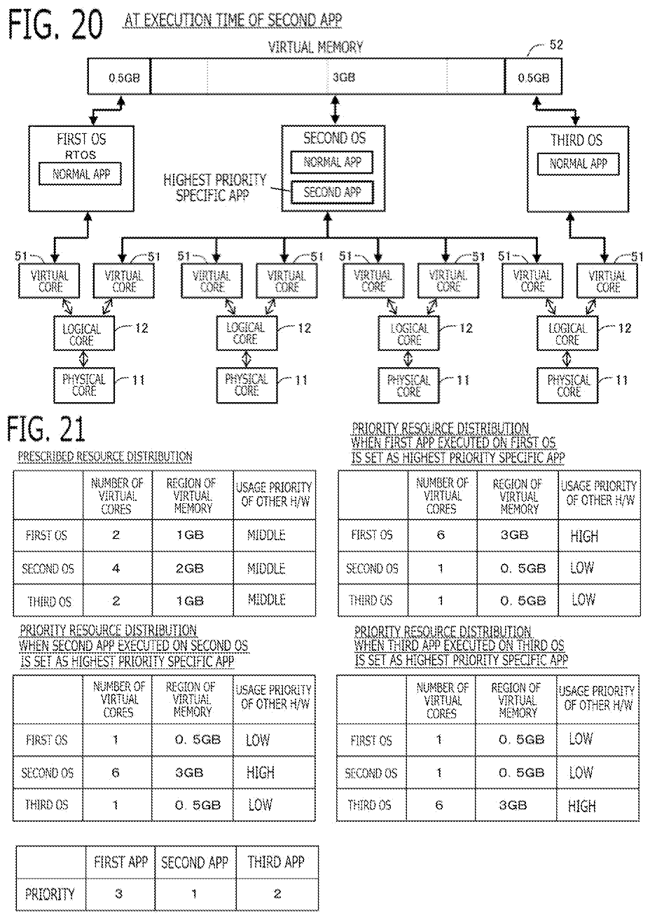

FIG. 20 shows a case where the execution of the third APP of the third OS is ended and the second APP is executed on the second OS, from the state of FIG. 19. Accordingly, the second APP of the second OS is determined to be the highest priority specific APP. Accordingly, the second OS is assigned the six virtual cores 51 and 3 GB region of the virtual memory 52 which are more than the resources (four, 2 GB) of the second OS set in the prescribed resource distribution of FIG. 17. The second OS and the second APP operate using these resources at higher speed than the state of the prescribed resource distribution. On the other hand, the first OS and the third OS are assigned the one virtual core 51 and 0.5 GB region of the virtual memory 52 which are less than the resources (two, 1 BG) of the first OS and the third OS set in the prescribed resource distribution of FIG. 17. However, since the resources are decreased within a range that the first OS and the third OS can continue operation, there is no particular problem.

The usage priority of other H/W 30 of the second OS may be made higher than the usage priority of the first OS and the third OS. For example, as the usage priority of each OS becomes high, a time occupancy of other H/W 30 of each OS is increased.

Then, after the end of execution of the second APP, since no other specific APP is executed, the resource distribution becomes in the state of the prescribed resource distribution shown in FIG. 17.

By referring a resource distribution table data in which the prescribed resource distribution and the priority resource distribution for each the specific APP are preliminarily set as shown in FIG. 21, the operation control unit 60 reads the prescribed resource distribution or the priority resource distribution corresponding to a present execution state of the APPs, and sets as the resource distribution. In detail, when the specific APP is not included in the APPs which are executed presently, the operation control unit 60 reads the prescribed resource distribution from the resource distribution table data, and sets it as the resource distribution. When the specific APP is included in the APPs which are executed presently, the operation control unit 60 determines the APP with the highest priority among the specific APPs, reads the priority resource distribution corresponding to the specific APP determined as the highest priority specific APP, and sets it as the resource distribution. The resource distribution table data is preliminarily stored in the nonvolatile memories 22, such as ROM.

For example, as shown in FIG. 21, in the resource distribution table data, in addition to the prescribed resource distribution, the priority resource distribution is preliminarily set for each of the first APP, the second APP, and the third APP which are the specific APPs. Then, when the highest priority specific APP is the first APP executed on the first OS, the priority resource distribution corresponding to the first APP is read and set as the resource distribution. When the highest priority specific APP is the second APP executed on the second OS, the priority resource distribution corresponding to the second APP is read and set as the resource distribution. When the highest priority specific APP is the third APP executed on the third OS, the priority resource distribution corresponding to the third APP is read and set as the resource distribution.

The usage priority of other H/W 30 of each OS is also set in each resource distribution. As the usage priority of each OS becomes high, the time occupancy of other H/W 30 of each OS is increased.

### <Flowchart>

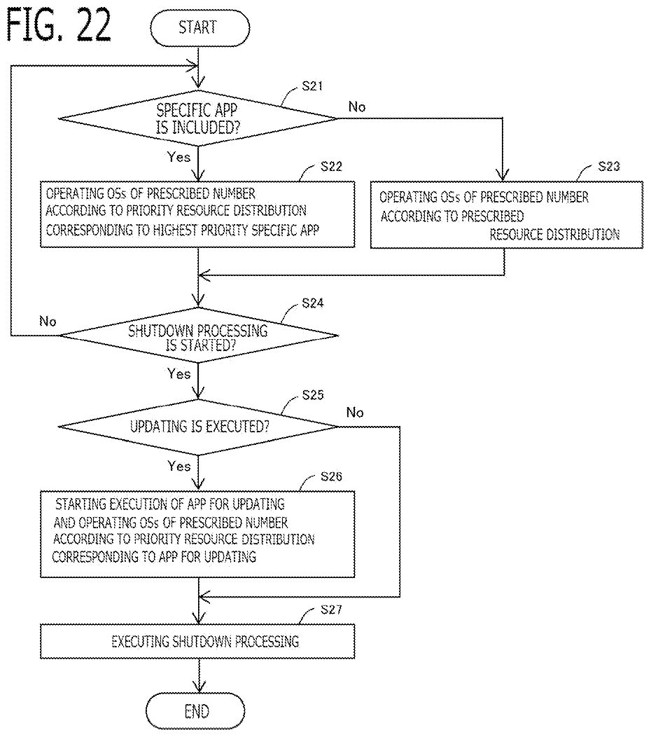

FIG. 22 is a schematic flowchart explaining processing of the arithmetic processing apparatus 1 (an arithmetic processing method) according to the present embodiment. The processing of FIG. 22 is executed by the physical processor 10 executing the software (program) stored in the memory 20 (the nonvolatile memory 22) and the like.

After the completion of the starting of the OSs of the prescribed number by the flowchart of FIG. 8 of Embodiment 1 or the flowchart of FIG. 16 of Embodiment 2, in the step S21 to the step S23, the operation control unit 60 executes an operation control processing (a control operation step) of determining a resource distribution which is a number of the virtual processor cores and a region of the virtual memory to be assigned to each of OSs of a prescribed number operating on the virtualization system, and operating the OSs of the prescribed number according to the resource distribution.

In the step S21, as mentioned above, the operation control unit 60 determines whether or not a preliminarily set one or a plurality of specific APPs are included in one or a plurality of APPs which are executed on each OS. When the specific APP is included in the APPs during execution, it advances to the step S22, and when the specific APP is not included in the APPs during execution, it advances to the step S23.

In the step S22, the operation control 60 determines a highest priority specific APP which is the specific APP with the highest priority, from the included specific APPs; determines a priority resource distribution which is the resource distribution corresponding to the highest priority specific APP; sets the priority resource distribution as the resource distribution; and operates the OSs of the prescribed number according to the resource distribution. When the number of the included specific APPs is one, the one specific APP is determined to be the highest priority specific APP.

In the step S23, the operation control 60 determines a prescribed resource distribution; sets the prescribed resource distribution as the resource distribution; and operates the OSs of the prescribed number according to the resource distribution.

In the step S24, the operation control unit 60 determines whether or not a shutdown process of the arithmetic processing apparatus 1 is started. When the shutdown process is determined to be started, it advances to the step S25, and when the shutdown process is determined not to be started, it returns to the step S21 and processing is continued.

In the step S25, the operation control unit 60 determines whether or not the updating of the OS and the APP is executed. When the updating is determining to be performed, it advances to the step S26, and when the updating is determining not to be performed, it advances to the step S27. For example, the operation control unit 60 asks a managing server via a wireless communication and a network whether or not the updating is necessary. When the updating is necessary, and the user agreed on the execution of updating, the updating is determined to be executed.

In the step S26, the operation control unit 60 starts the execution of the APP for the updating. Since the APP for the updating is the specific APP and the priority is made higher than other APPs, it is determined as the highest priority specific APP. Then, the operation control unit 60 determines the priority resource distribution corresponding to the APP for the updating which is the highest priority specific APP, sets the priority resource distribution as the resource distribution; and operates the OSs of the prescribed number according to the resource distribution. Accordingly, the processing of the APP for the updating is be speeded up, and a completion of updating can be speeded up. The operation control unit 60 advances to the step S27 after the completion of updating.

In the step S27, the virtualization unit 50 and the operation control unit 60 perform the shutdown processing of the arithmetic processing apparatus 1, and shuts down the arithmetic processing apparatus 1.

### <Summary of Aspects of the Present Disclosure>

Hereinafter, the aspects of the present disclosure is summarized as appendixes.

### (Appendix 1)

An arithmetic processing apparatus comprising:
a physical processor and a memory used by the physical processor;
a virtualization unit that generates a virtualization system having a plurality of virtual processor cores and a virtual memory that operates using the physical processor and the memory; and
an operation control unit that determines an operating number of OSs which are operating systems operating on the virtualization system, and a resource distribution which is a number of the virtual processor cores and a region of the virtual memory to be assigned to each of the OSs of the operating number, and operates the OSs of the operating number according to the resource distribution,
wherein the operation control unit completes a starting of each of the OSs of two or more prescribed numbers in order, according to a start completion order, after a completion of a generation of the virtualization system;
sets the resource distribution assigned to each of OSs of the prescribed number, to a preliminarily set prescribed resource distribution, after a completion of the starting of the OSs of the prescribed number;
during the starting of the OSs of the prescribed number, makes a number of the virtual processor cores and a region of the virtual memory to be assigned to the OS during an entire starting which starts the entire OS more than the number of the virtual processor cores and the region of the virtual memory of the OS during the entire starting which are set in the prescribed resource distribution; and
when the started OS is a specific OS, makes a number of the virtual processor cores and a region of the virtual memory to be assigned to the specific OS less than the number of the virtual processor cores and the region of the virtual memory of the specific OS which are set in the prescribed resource distribution, and assigns reduced resources to the OS during the entire starting.

### (Appendix 2)

The arithmetic processing apparatus according to appendix 1,
wherein the OSs of the prescribed number include RTOS which is a real time operating system, and
wherein the operation control unit first completes a starting of the RTOS, after the completion of the generation of the virtualization system.

### (Appendix 3)

The arithmetic processing apparatus according to appendix 1 or 2,
wherein the specific OS is set to one or a plurality of OSs other than the OS which is started last.

### (Appendix 4)

The arithmetic processing apparatus according to any one of appendixes 1 to 3,
wherein each of the OSs of the prescribed number is provided with an operating state monitoring unit that monitors an operating state of the own OS,
wherein, during the starting of the OSs of the prescribed number, the operation control unit assigns, to the OS before the start of the entire starting, a minimum number of the virtual processor cores and a minimum region of the virtual memory which are less than the number of the virtual processor cores and the region of the virtual memory of the OS before the start of the entire starting which are set in the prescribed resource distribution, and are for operating at least the operating state monitoring unit of the OS before the start of the entire starting; and starts partially and operates the operating state monitoring unit of the OS, before the start of the entire starting,
wherein the operating state monitoring unit of each of the OSs transmits a starting status of the corresponding OS, to the operation control unit,
wherein the operation control unit starts the entire starting of each of the OSs in order, according to the start completion order, based on the starting status of each of the OSs transmitted from the operating state monitoring unit of each of the OSs; and completes the starting of each of the OSs of the prescribed number in order.

### (Appendix 5)

An arithmetic processing apparatus comprising:
a physical processor and a memory used by the physical processor;
a virtualization unit that generates a virtualization system having a plurality of virtual processor cores and a virtual memory that operates using the physical processor and the memory; and
an operation control unit that determines an operating number of OSs which are operating systems operating on the virtualization system, and a resource distribution which is a number of the virtual processor cores and a region of the virtual memory to be assigned to each of the OSs of the operating number, and operates the OSs of the operating number according to the resource distribution,
wherein the operation control unit completes a starting of each of the OSs of two or more prescribed numbers in order, according to a start completion order, after a completion of a generation of the virtualization system; and sets the resource distribution assigned to each of OSs of the prescribed number, to a preliminarily set prescribed resource distribution, after a completion of the starting of the OSs of the prescribed number,
wherein each of the OSs of the prescribed number is provided with an operating state monitoring unit that monitors an operating state of the own OS,
wherein, during the starting of the OSs of the prescribed number, the operation control unit assigns, to the OS before the start of the entire starting, a minimum number of the virtual processor cores and a minimum region of the virtual memory which are less than the number of the virtual processor cores and the region of the virtual memory of the OS before the start of the entire starting which are set in the prescribed resource distribution, and are for operating at least the operating state monitoring unit of the OS before the start of the entire starting; and starts partially and operates the operating state monitoring unit of the OS, before the start of the entire starting;
wherein the operating state monitoring unit of each of the OSs transmits a starting status of the corresponding OS to the operation control unit,
wherein the operation control unit starts the entire starting of each of the OSs in order, according to the start completion order, based on the starting status of each of the OSs transmitted from the operating state monitoring unit of each of the OSs; and completes the starting of each of the OSs of the prescribed number in order.

### (Appendix 6)

The arithmetic processing apparatus according to any one of appendixes 1 to 5,
wherein, by referring to a resource distribution table data in which the prescribed resource distribution and a resource distribution during the entire starting which is a resource distribution set for each the OS during the entire starting are preliminarily set, the operation control unit reads the prescribed resource distribution or the resource distribution during the entire starting corresponding to a present starting status, and sets as the resource distribution.

### (Appendix 7)

The arithmetic processing apparatus according to any one of appendixes 1 to 6,
wherein the physical processor is provided with a plurality of physical processor cores, and
wherein the virtualization system generates a plurality of the virtual processor cores for each the physical processor core.

### (Appendix 8)

The arithmetic processing apparatus according to any one of appendixes 1 to 7,
wherein, after the completion of the starting of OSs of the prescribed number,
when one or a plurality of preliminarily set specific APPs are included in one or a plurality of APPs which are application systems executed on each the OS, the operation control unit determines a highest priority specific APP which is the specific APP with the highest priority, from the included one or the plurality of specific APPs; determines a priority resource distribution which is the resource distribution corresponding to the highest priority specific APP; and sets the priority resource distribution as the resource distribution,
when the one or the plurality of specific APPs are not included, the operation control unit determines a prescribed resource distribution; and sets the prescribed resource distribution as the resource distribution, in the priority resource distribution, the operation control unit makes a number of the virtual processor cores and a region of the virtual memory to be assigned to a highest priority corresponding OS which is the OS on which the highest priority specific APP is executed more than the number of the virtual processor cores and the region of the virtual memory of the highest priority corresponding OS which are set in the prescribed resource distribution.

### (Appendix 9)

An arithmetic processing apparatus comprising:
a physical processor and a memory used by the physical processor;
a virtualization unit that generates a virtualization system having a plurality of virtual processor cores and a virtual memory that operates using the physical processor and the memory; and an operation control unit that determines a resource distribution which is a number of the virtual processor cores and a region of the virtual memory to be assigned to each of OSs which are operating systems of a prescribed number operating on the virtualization system, and operates the OSs of the prescribed number according to the resource distribution,
wherein, after a completion of a starting of the OSs of the prescribed number,
when one or a plurality of preliminarily set specific APPs are included in one or a plurality of APPs which are application systems executed on each the OS, the operation control unit determines a highest priority specific APP which is the specific APP with the highest priority, from the included one or the plurality of specific APPs; determines a priority resource distribution which is the resource distribution corresponding to the highest priority specific APP; and sets the priority resource distribution as the resource distribution,
when the one or the plurality of specific APPs are not included, the operation control unit determines a prescribed resource distribution; and sets the prescribed resource distribution as the resource distribution, and
in the priority resource distribution, the operation control unit makes a number of the virtual processor cores and a region of the virtual memory to be assigned to a highest priority corresponding OS which is the OS on which the highest priority specific APP is executed more than the number of the virtual processor cores and the region of the virtual memory of the highest priority corresponding OS which are set in the prescribed resource distribution.

### (Appendix 10)

The arithmetic processing apparatus according to appendix 8 or 9,
wherein, by referring a resource distribution table data in which the prescribed resource distribution and the priority resource distribution for each the specific APP are preliminarily set, the operation control unit reads the prescribed resource distribution or the priority resource distribution corresponding to a present execution state of the APPs, and sets as the resource distribution.

### (Appendix 11)

The arithmetic processing apparatus according to any one of appendixes 8 to 10,
wherein the arithmetic processing apparatus is an arithmetic processing apparatus for a vehicle,
wherein the specific APP is set to an APP for an emergency driving of the vehicle, and the priority of the APP for the emergency driving of the vehicle is made higher than other APPs.

### (Appendix 12)

The arithmetic processing apparatus according to any one of appendixes 8 to 11,
wherein the arithmetic processing apparatus is an arithmetic processing apparatus for a vehicle,
wherein the specific APP is set to an APP during a vehicle stop which is executed only during a stop of the vehicle, and the priority of the APP during the vehicle stop is made higher than other APPs which are executed also during other than the vehicle stop.

### (Appendix 13)

The arithmetic processing apparatus according to appendix 12,
wherein the APP during the vehicle stop which is set as the specific APP is an APP for an updating which updates the OS and the APP before a shutdown of the arithmetic processing apparatus; and the priority of the APP for the updating is made higher than other APPs which are executed during the vehicle stop.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. An arithmetic processing apparatus comprising:
a physical processor and a memory used by the physical processor;
a virtualization generator that generates a virtualization system having a plurality of virtual processor cores and a virtual memory that operates using the physical processor and the memory; and
an operation controller that determines an operating number of OSs which are operating systems operating on the virtualization system, and a resource distribution which is a number of the virtual processor cores and a region of the virtual memory to be assigned to each of the OSs of the operating number, and operates the OSs of the operating number according to the resource distribution,
wherein the operation controller completes a starting of each of the OSs of two or more prescribed numbers in order, according to a start completion order, after a completion of a generation of the virtualization system;
sets the resource distribution assigned to each of OSs of the prescribed number, to a preliminarily set prescribed resource distribution, after a completion of the starting of the OSs of the prescribed number;
during the starting of the OSs of the prescribed number, makes a number of the virtual processor cores and a region of the virtual memory to be assigned to the OS during an entire starting which starts the entire OS more than the number of the virtual processor cores and the region of the virtual memory of the OS during the entire starting which are set in the prescribed resource distribution; and
when the started OS is a specific OS, makes a number of the virtual processor cores and a region of the virtual memory to be assigned to the specific OS less than the number of the virtual processor cores and the region of the virtual memory of the specific OS which are set in the prescribed resource distribution, and assigns reduced resources to the OS during the entire starting.

2. The arithmetic processing apparatus according to claim 1,
wherein the OSs of the prescribed number include RTOS which is a real time operating system, and
wherein the operation controller first completes a starting of the RTOS, after the completion of the generation of the virtualization system.

3. The arithmetic processing apparatus according to claim 1,
wherein the specific OS is set to one or a plurality of OSs other than the OS which is started last.

4. The arithmetic processing apparatus according to claim 1,
wherein each of the OSs of the prescribed number is provided with an operating state monitor that monitors an operating state of the own OS,
wherein, during the starting of the OSs of the prescribed number, the operation controller assigns, to the OS before the start of the entire starting, a minimum number of the virtual processor cores and a minimum region of the virtual memory which are less than the number of the virtual processor cores and the region of the virtual memory of the OS before the start of the entire starting which are set in the prescribed resource distribution, and are for operating at least the operating state monitor of the OS before the start of the entire starting; and starts partially and operates the operating state monitor of the OS, before the start of the entire starting,
wherein the operating state monitor of each of the OSs transmits a starting status of the corresponding OS, to the operation controller,
wherein the operation controller starts the entire starting of each of the OSs in order, according to the start completion order, based on the starting status of each of the OSs transmitted from the operating state monitor of each of the OSs; and completes the starting of each of the OSs of the prescribed number in order.

5. An arithmetic processing apparatus comprising:
a physical processor and a memory used by the physical processor;
a virtualization generator that generates a virtualization system having a plurality of virtual processor cores and a virtual memory that operates using the physical processor and the memory; and
an operation controller that determines an operating number of OSs which are operating systems operating on the virtualization system, and a resource distribution which is a number of the virtual processor cores and a region of the virtual memory to be assigned to each of the OSs of the operating number, and operates the OSs of the operating number according to the resource distribution,
wherein the operation controller completes a starting of each of the OSs of two or more prescribed numbers in order, according to a start completion order, after a completion of a generation of the virtualization system; and sets the resource distribution assigned to each of OSs of the prescribed number, to a preliminarily set prescribed resource distribution, after a completion of the starting of the OSs of the prescribed number,
wherein each of the OSs of the prescribed number is provided with an operating state monitor that monitors an operating state of the own OS,
wherein, during the starting of the OSs of the prescribed number, the operation controller assigns, to the OS before the start of the entire starting, a minimum number of the virtual processor cores and a minimum region of the virtual memory which are less than the number of the virtual processor cores and the region of the virtual memory of the OS before the start of the entire starting which are set in the prescribed resource distribution, and are for operating at least the operating state monitor of the OS before the start of the entire starting; and starts partially and operates the operating state monitor of the OS, before the start of the entire starting;
wherein the operating state monitor of each of the OSs transmits a starting status of the corresponding OS to the operation controller,
wherein the operation controller starts the entire starting of each of the OSs in order, according to the start completion order, based on the starting status of each of the OSs transmitted from the operating state monitor of each of the OSs; and completes the starting of each of the OSs of the prescribed number in order.

6. The arithmetic processing apparatus according to claim 1,
wherein, by referring to a resource distribution table data in which the prescribed resource distribution and a resource distribution during the entire starting which is a resource distribution set for each the OS during the entire starting are preliminarily set, the operation controller reads the prescribed resource distribution or the resource distribution during the entire starting corresponding to a present starting status, and sets as the resource distribution.

7. The arithmetic processing apparatus according to claim 1,
wherein the physical processor is provided with a plurality of physical processor cores, and
wherein the virtualization system generates a plurality of the virtual processor cores for each the physical processor core.

8. The arithmetic processing apparatus according to claim 1,
wherein, after the completion of the starting of OSs of the prescribed number,
when one or a plurality of preliminarily set specific APPs are included in one or a plurality of APPs which are application systems executed on each the OS, the operation controller determines a highest priority specific APP which is the specific APP with the highest priority, from the included one or the plurality of specific APPs; determines a priority resource distribution which is the resource distribution corresponding to the highest priority specific APP; and sets the priority resource distribution as the resource distribution,
when the one or the plurality of specific APPs are not included, the operation controller determines a prescribed resource distribution; and sets the prescribed resource distribution as the resource distribution,
in the priority resource distribution, the operation controller makes a number of the virtual processor cores and a region of the virtual memory to be assigned to a highest priority corresponding OS which is the OS on which the highest priority specific APP is executed more than the number of the virtual processor cores and the region of the virtual memory of the highest priority corresponding OS which are set in the prescribed resource distribution.

9. An arithmetic processing apparatus comprising:
a physical processor and a memory used by the physical processor;
a virtualization generator that generates a virtualization system having a plurality of virtual processor cores and a virtual memory that operates using the physical processor and the memory; and
an operation controller that determines a resource distribution which is a number of the virtual processor cores and a region of the virtual memory to be assigned to each of OSs which are operating systems of a prescribed number operating on the virtualization system, and operates the OSs of the prescribed number according to the resource distribution,
wherein, after a completion of a starting of the OSs of the prescribed number,
when one or a plurality of preliminarily set specific APPs are included in one or a plurality of APPs which are application systems executed on each the OS, the operation controller determines a highest priority specific APP which is the specific APP with the highest priority, from the included one or the plurality of specific APPs; determines a priority resource distribution which is the resource distribution corresponding to the highest priority specific APP; and sets the priority resource distribution as the resource distribution,
when the one or the plurality of specific APPs are not included, the operation controller determines a prescribed resource distribution; and sets the prescribed resource distribution as the resource distribution, and
in the priority resource distribution, the operation controller makes a number of the virtual processor cores and a region of the virtual memory to be assigned to a highest priority corresponding OS which is the OS on which the highest priority specific APP is executed more than the number of the virtual processor cores and the region of the virtual memory of the highest priority corresponding OS which are set in the prescribed resource distribution.

10. The arithmetic processing apparatus according to claim 9,
wherein, by referring a resource distribution table data in which the prescribed resource distribution and the priority resource distribution for each the specific APP are preliminarily set, the operation controller reads the prescribed resource distribution or the priority resource distribution corresponding to a present execution state of the APPs, and sets as the resource distribution.

11. The arithmetic processing apparatus according to claim 9,
wherein the arithmetic processing apparatus is an arithmetic processing apparatus for a vehicle,
wherein the specific APP is set to an APP for an emergency driving of the vehicle, and the priority of the APP for the emergency driving of the vehicle is made higher than other APPs.

12. The arithmetic processing apparatus according to claim 9,
wherein the arithmetic processing apparatus is an arithmetic processing apparatus for a vehicle,
wherein the specific APP is set to an APP during a vehicle stop which is executed only during a stop of the vehicle, and the priority of the APP during the vehicle stop is made higher than other APPs which are executed also during other than the vehicle stop.

13. The arithmetic processing apparatus according to claim 12,
wherein the APP during the vehicle stop which is set as the specific APP is an APP for an updating which updates the OS and the APP before a shutdown of the arithmetic processing apparatus; and the priority of the APP for the updating is made higher than other APPs which are executed during the vehicle stop.

14. An arithmetic processing method that makes a physical processor and a memory used by the physical processor perform each following step, comprising:
a virtualization step of generating a virtualization system having a plurality of virtual processor cores and a virtual memory that operates using the physical processor and the memory; and
an operation control step of determining an operating number of OSs which are operating systems operating on the virtualization system, and a resource distribution which is a number of the virtual processor cores and a region of the virtual memory to be assigned to each of the OSs of the operating number, and operating the OSs of the operating number according to the resource distribution,
wherein, in the operation control step, completing a starting of each of the OSs of two or more prescribed numbers in order, according to a start completion order, after a completion of a generation of the virtualization system;
setting the resource distribution assigned to each of OSs of the prescribed number, to a preliminarily set prescribed resource distribution, after a completion of the starting of the OSs of the prescribed number;
during the starting of the OSs of the prescribed number, making a number of the virtual processor cores and a region of the virtual memory to be assigned to the OS during an entire starting which starts the entire OS more than the number of the virtual processor cores and the region of the virtual memory of the OS during the entire starting which are set in the prescribed resource distribution; and
when the started OS is a specific OS, making a number of the virtual processor cores and a region of the virtual memory to be assigned to the specific OS less than the number of the virtual processor cores and the region of the virtual memory of the specific OS which are set in the prescribed resource distribution, and assigning reduced resources to the OS during the entire starting.

15. An arithmetic processing method that makes a physical processor and a memory used by the physical processor perform each following step, comprising:
a virtualization step of generating a virtualization system having a plurality of virtual processor cores and a virtual memory that operates using the physical processor and the memory; and
an operation control step of determining an operating number of OSs which are operating systems operating on the virtualization system, and a resource distribution which is a number of the virtual processor cores and a region of the virtual memory to be assigned to each of the OSs of the operating number, and operating the OSs of the operating number according to the resource distribution,
wherein, in the operation control step, completing a starting of each of the OSs of two or more prescribed numbers in order, according to a start completion order, after a completion of a generation of the virtualization system; and
setting the resource distribution assigned to each of OSs of the prescribed number, to a preliminarily set prescribed resource distribution, after a completion of the starting of the OSs of the prescribed number,
wherein each of the OSs of the prescribed number is provided with an operating state monitor that monitors an operating state of the own OS,
wherein, in the operation control step, during the starting of the OSs of the prescribed number, assigning, to the OS before the start of the entire starting, a minimum number of the virtual processor cores and a minimum region of the virtual memory which are less than the number of the virtual processor cores and the region of the virtual memory of the OS before the start of the entire starting which are set in the prescribed resource distribution, and are for operating at least the operating state monitor of the OS before the start of the entire starting; and starting partially and operates the operating state monitor of the OS, before the start of the entire starting,
wherein, in the operation control step, starting the entire starting of each of the OSs in order, according to the start completion order, based on the starting status of each of the OSs transmitted from the operating state monitor of each of the OSs;
and completing the starting of each of the OSs of the prescribed number in order.

16. An arithmetic processing method that makes a physical processor and a memory used by the physical processor perform each following step, comprising:
a virtualization step of generating a virtualization system having a plurality of virtual processor cores and a virtual memory that operates using the physical processor and the memory; and
an operation control step of determining a resource distribution which is a number of the virtual processor cores and a region of the virtual memory to be assigned to each of OSs which are operating systems of a prescribed number operating on the virtualization system, and operating the OSs of the prescribed number according to the resource distribution,
wherein, in the operation control step, after a completion of a starting of OSs of the prescribed number,
when one or a plurality of preliminarily set specific APPs are included in one or a plurality of APPs which are application systems executed on each the OS, determining a highest priority specific APP which is the specific APP with the highest priority, from the included one or the plurality of specific APPs; determining a priority resource distribution which is the resource distribution corresponding to the highest priority specific APP; and setting the priority resource distribution as the resource distribution,
when the one or the plurality of specific APPs are not included, determining a prescribed resource distribution; and setting the prescribed resource distribution as the resource distribution,
in the priority resource distribution, the operation controller makes a number of the virtual processor cores and a region of the virtual memory to be assigned to a highest priority corresponding OS which is the OS on which the highest priority specific APP is executed more than the number of the virtual processor cores and the region of the virtual memory of the highest priority corresponding OS which are set in the prescribed resource distribution.
